(19) United States
(12) Patent Application Publication
(10) Pub. No.: US 2015/0246774 A1
(43) Pub. Date: Sep. 3, 2015

(54) Method of Hauling Matter on a Sheet of Material

(71) Applicant: Barry S. Fernandes, Harwich, MA (US)

(72) Inventor: Barry S. Fernandes, Harwich, MA (US)

(21) Appl. No.: 14/634,868

(22) Filed: Mar. 1, 2015

Related U.S. Application Data
(60) Provisional application No. 61/947,322, filed on Mar. 3, 2014.

(51) Int. Cl. B65G 7/02

(52) U.S. Cl. CPC B65G 7/02

(57) ABSTRACT

A method of hauling matter, including selecting a tool having a handle attached to a hook, and placing matter onto a sheet of material. The sheet is engaged with the hook in at least three positions, and the handle is pulled to haul the sheet with matter thereon.

### CROSS-REFERENCE TO RELATED APPLICATION

This application claims priority to U.S. Provisional Application No. 61/947,322 filed 03 Mar. 2014. The entire contents of the above-mentioned application is incorporated herein by reference.

### FIELD OF THE INVENTION

The invention relates to techniques for hauling initially free, unbundled matter and more particularly to moving yard items and other matter utilizing a sheet of material such as a tarpaulin.

### BACKGROUND OF THE INVENTION

Bundled objects such as hay bales or graspable objects such as logs or blocks of ice have been directly engaged by hooks, tongs or other tools for centuries. Features have been added to simple hooks, such as the combined hook and hammer disclosed in U.S. Pat. No. 542,178 by Tillett et al., which serves as a grab-hook for “all kinds of bales, boxes, baggage, barrels, and bundles of every nature and description having any considerable bulk and weight . . . ”. A quick-release hay hook with a pivoting handle is described by Penington et al. in U.S. Pat. No. No. 931,339 as useful for handling commodities placed in bales, sacks or bags.

There are many situations in which a person desires to gather and transport initially free, unbundled or unconstrained matter such as mulch, fallen leaves, clippings, twigs and branches, debris or other matter. The initially free matter often is gathered by raking the matter onto a flexible sheet of material such as a tarpaulin, commonly referred to as a tarp, typically having dimensions of six feet by eight feet, seven feet by nine feet, or larger sizes. The person using the tarp must then grasp one or more corners and/or edges of the tarp to control matter lying loosely on the tarp, and then pull on the grasped corners and/or edges to drag or lift the loaded tarp directly to a place for final disposal or to a transport vehicle for subsequent disposal.

If the grip of the user becomes overly relaxed or fatigued while hauling the tarp, or if the user slips, one or more edges of the tarp may drop to spill the gathered matter. Spillage delays the process and can frustrate and further tire the user.

It is therefore desirable to have an improved method of hauling yard items and other matter.

### SUMMARY OF THE INVENTION

An object of the present invention is to provide an improved and more reliable method of hauling initially free matter such as yard items placed on a sheet of material.

Another object of the present invention is to reduce fatigue of a person hauling the matter.

Yet another object of the present invention is to increase control of and minimize spillage of matter placed on the sheet.

This invention results from the realization that leaves and other initially free matter can be hauled more effectively utilizing a tool which engages multiple positions on a tarp, preferably “streamlining” the tarp relative to the ground over which it will be hauled.

This invention features a method of hauling matter, including selecting a tool having a handle attached to a hook, and placing matter onto a sheet of material. The sheet is engaged with the hook in at least three positions, and the handle is pulled to haul the sheet with matter thereon.

In some embodiments, the handle is pivotally attached to the hook, with at least one degree of freedom of movement, and the handle preferably includes an ergonomic, cushioned grip of a resilient material having a higher coefficient of friction than the material of which the handle is made. In one embodiment, the handle is formed of a metallic material and the grip is formed of a polymeric material. The grip facilitates grasping of the handle by a hand of a user.

This invention may also be expressed as a method of hauling yard items such as mulch, leaves or twigs by selecting a tool having a handle pivotally attached to a hook, the hook having a tip that is sufficiently small to pass through an eyelet commonly found in tarpaulins. The method further includes gathering the yard items onto a tarpaulin having at least four corners and at least four edges extending between the corners, at least first and second corners each having a first corner eyelet and a second corner eyelet, respectively. At least a first edge extends between the first and second corners and has a center edge eyelet disposed approximately at a center of that edge between the first and second corner eyelets. The tarpaulin is engaged with the hook through at least the center edge eyelet and through at least the first and second corner eyelets with the yard items placed on the tarpaulin. The handle is then pulled to haul the tarpaulin with yard items to another location for disposal of the yard items.

### BRIEF DESCRIPTION OF THE DRAWINGS

In what follows, preferred embodiments of the invention are explained in more detail with reference to the drawings, in which:

FIG. 1 is a schematic perspective view of a novel tool having a hook suitable for use according to the present invention;

FIG. 2 is a view similar to FIG. 1 with the hook engaging an eyelet of a sheet;

FIG. 3 is a partial perspective view of a sheet having grommets and with yard items placed on the sheet;

FIG. 4 is a flowchart showing steps for one technique according to the present invention; and

FIG. 5 is a schematic top plan view of yard items placed on another type of sheet to be hauled according to the present invention.

### DETAILED DESCRIPTION OF THE PRESENTLY PREFERRED EMBODIMENTS

This invention may be accomplished by an improved technique of hauling matter on a sheet of material utilizing a tool that increases control of the sheet and reduces user fatigue. The tool is selected to have a handle attached to a hook, which is fixed in some constructions and, in other constructions, is pivotable with at least one degree of freedom relative to the handle. At a first location, matter such as fallen leaves or other yard items is placed onto a sheet of material such as a tarp. The sheet is engaged with the hook in at least three positions on the sheet, and the handle is pulled to haul the sheet with matter thereon to another location.

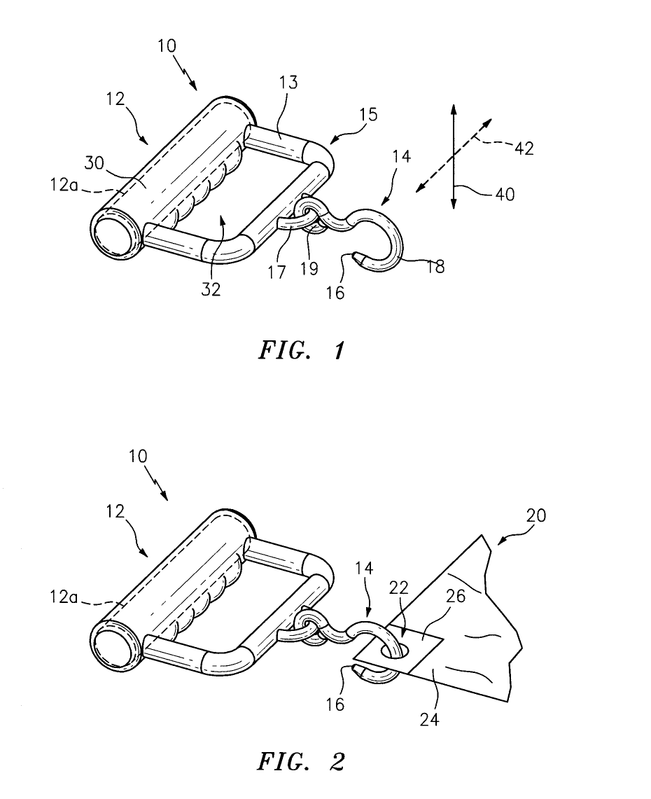

In one method according to the present invention, a novel tool 10, FIGS. 1 and 2, is selected to have a handle 12 pivotally attached to a hook 14. The hook 14 has a curved portion 18 terminating in a tip 16, preferably blunt to avoid injury to a user, that is sufficiently small to pass through an eyelet 22, FIG. 2, commonly found in tarpaulins such as tarp 20. In this construction, eyelet 22 is defined by a hole in sheet material 24 and in reinforcing material 26 which serves as a grommet. The composition of reinforcing material 26 is the same as that of sheet material 24 in some constructions and, in other constructions is a different material, such as a metallic material or a polymeric material that adds strength to sheet material 24 in the vicinity of eyelet 22.

Materials utilized to form tool 10 preferably are durable and weather-resistant for repeated outdoor use. In one construction, handle 12 is a six-inch section of round steel stock 12a, approximately one inch in diameter and either solid or hollow, to which is welded a smaller-diameter, solid steel rod 13 to establish a rectangular bracket 15 that extends approximately three inches down from the bottom of the handle 12 and runs almost the entire length of stock 12a. The bottom of this rectangular bracket 15 in turn features a centered eye-strap 17, also of welded solid steel rod, and supports freely articulating, round steel hook 14.

As illustrated, the hook 14 is freely movable up and down in the directions illustrated by solid arrow 40, which represents a first degree of freedom. In this construction, hook 14 is also movable side-to-side in the directions illustrated by dashed arrow 42, representing another degree of freedom for hook 14, as provided by curved portion 19 of hook 14 that is bent around eye-strap 17.

In this construction, steel stock handle 12 is coated with a foam material 30 that preferably is somewhat resilient to provide a comfortable, secure grip and to lessen fatigue during extended use. It is also preferable for material 30 to have a higher coefficient of friction than that of stock 12a to reduce slippage in a hand of a user. A series of projections and indentations 32.

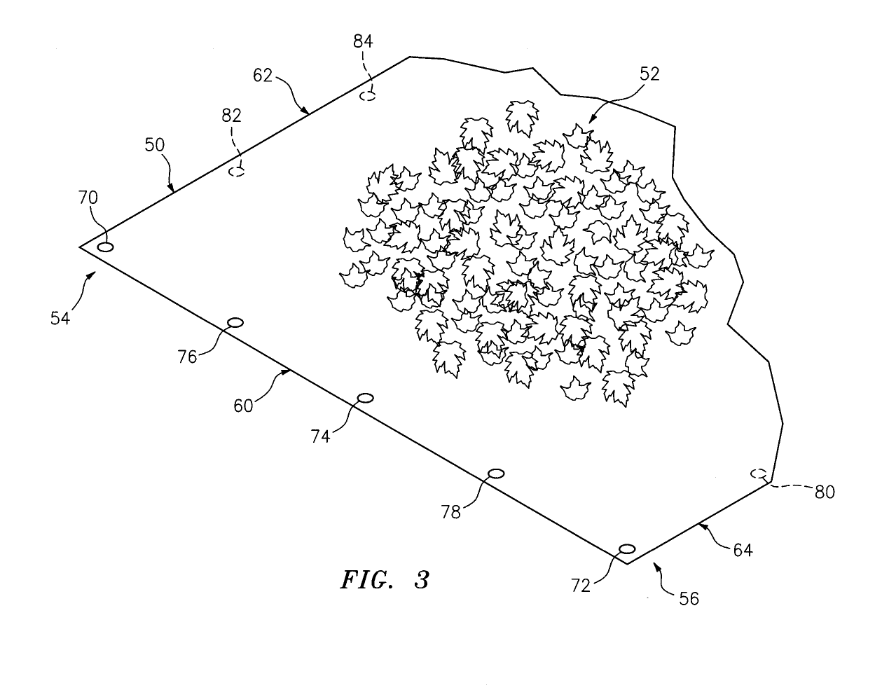

In addition to selecting a suitable tool, one method according to the present invention further includes gathering, such as by raking, and placing matter such as yard items 52, FIG. 3, onto a sheet of material such as tarpaulin 50 having at least first and second corners 54, 56 and at least an edge 60 extending between the corners 54, 56. Tarp 50 also includes at least edges 62 and 64 in this construction. At least first and second corners 54, 56 each have a first corner eyelet 70 and a second corner eyelet 72, respectively, such as defined by reinforcing grommets. The first edge 60 has a center edge eyelet 74 disposed approximately at a center of edge 60 between the first and second corner eyelets 70, 72. Preferably, at least the first edge 60 has second and third edge eyelets 76, 78 disposed on opposite sides of the center eyelet 74, and each eyelet is defined and/or augmented by a grommet. Tarp 50 may include additional eyelets such as eyelets 80, 82 and 84 indicated in phantom on edges 64 and 62, respectively.

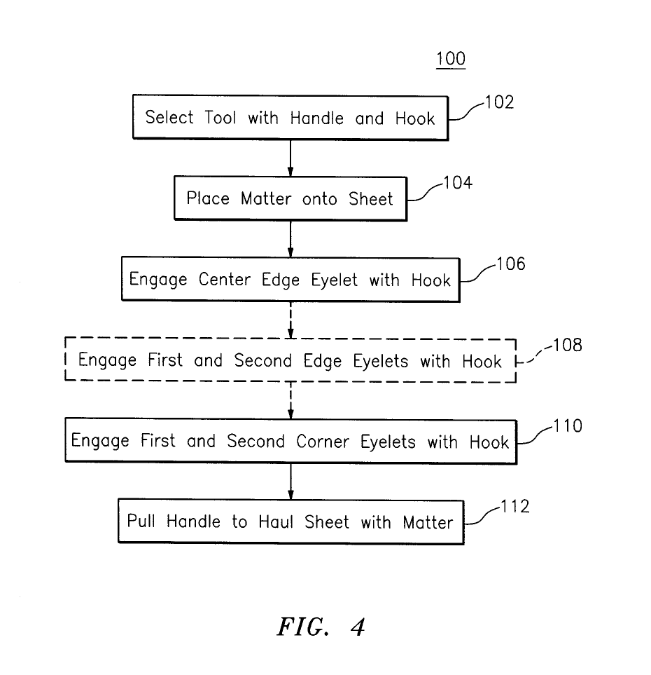

In a technique 100 according to the present invention as depicted in FIG. 4, a person such as a home owner, a landscaper, a farmer, or a tree worker selects a suitable tool with a handle and a hook, step 102. The user gathers and places mulch, pulled or cut weeds, twigs, branches or other matter onto a flexible, tear-resistant sheet, step 104, and then begins engaging the sheet at the center of one edge, step 106, such as the seven-foot edge of a seven-foot by nine-foot tarp, and then works outwardly to either side to “streamline” the engaged sheet relative to the ground over which it will be hauled. For example, the center edge eyelet is first engaged with the hook, the first and second edge eyelets are optionally next engaged with the hook, step 108 shown in phantom as an optional step, and then the first and second corner eyelets are engaged with the hook, step 110. The handle is then pulled to haul the sheet with yard items to another location, step 112, for disposal of the yard items by recycling, composting or other conventional disposal process.

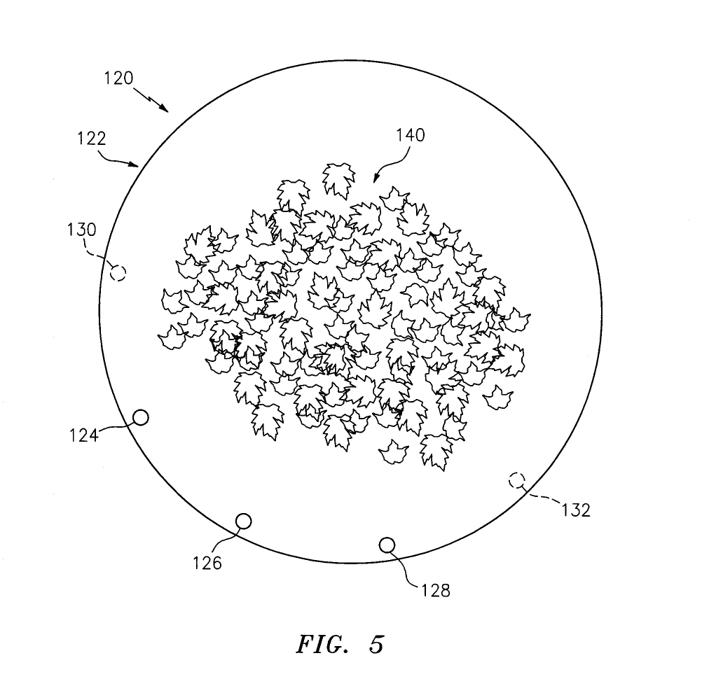

Although sheets have been described above as having multiple edges, this is not a limitation of the invention. For example, a suitable sheet 120, FIG. 5, has a single edge 122 around the periphery of sheet 120. At least three eyelets 124, 126 and 128 are defined in edge 122. Optional additional eyelets 130 and 130 are shown in phantom. Matter such as leaves 140 is placed on sheet 120, and then at least eyelets 124, 126 and 128 are engaged by a hook as described above to haul the sheet 120 and leaves 140 to another location.

Although specific features of the present invention are shown in some drawings and not in others, this is for convenience only, as each feature may be combined with any or all of the other features in accordance with the invention. While there have been shown, described, and pointed out fundamental novel features of the invention as applied to one or more preferred embodiments thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A method of hauling matter, comprising:
selecting a tool having a handle attached to a hook;
placing matter onto a sheet of material having at least one edge;
engaging the sheet with the hook in at least three positions; and
pulling the handle to haul the sheet with matter thereon.

2. The method of claim 1 wherein the at least one edge of the sheet is engaged at a plurality of positions along that edge.

3. The method of claim 1 wherein the handle is pivotally attached to the hook.

4. The method of claim 1 wherein the handle includes a grip that is graspable by a hand of a user.

5. The method of claim 4 wherein the grip includes resilient material to cushion the grip.

6. The method of claim 4 wherein the handle is formed of a metallic material and the grip is formed of a polymeric material.

7. A method of hauling matter comprising:
selecting a tool having a handle pivotally attached to a hook, the handle including a grip that is graspable by a hand of a user;
placing matter onto a sheet of material, the sheet having at least three edges;
engaging the sheet with the hook, including engaging one of the edges in at least three positions along that edge; and
grasping the handle and pulling the handle to haul the sheet with matter thereon.

8. The method of claim 7 wherein the sheet has at least four corners and at least four edges extending between the corners, and at least each corner and at least each edge has an eyelet that is engagable by the hook.

9. The method of claim 8 wherein each eyelet is defined by a grommet.

10. The method of claim 9 wherein the grip includes resilient material to cushion the grip.

11. The method of claim 10 wherein the handle is formed of a metallic material and the grip is formed of a polymeric material.

12. A method of hauling yard items, comprising:
selecting a tool having a handle pivotally attached to a hook, the hook having a tip that is sufficiently small to pass through an eyelet commonly found in tarpaulins;
gathering the yard items onto a tarpaulin having at least four corners and at least four edges extending between the corners, at least first and second corners each having a first corner eyelet and a second corner eyelet, respectively, and at least a first edge extending between the first and second corners having a center edge eyelet disposed approximately at a center of that edge between the first and second corner eyelets;
engaging the tarpaulin with the hook through at least the center edge eyelet and through at least the first and second corner eyelets with the yard items placed on the tarpaulin; and
pulling the handle to haul the tarpaulin with yard items to another location for disposal of the yard items.

13. The method of claim 12 wherein the handle includes a grip that is graspable by a hand of a user.

14. The method of claim 13 wherein the grip includes resilient material to cushion the grip.

15. The method of claim 13 wherein the handle is formed of a metallic material and the grip is formed of a polymeric material that has a higher coefficient of friction than that of the metallic material.

16. The method of claim 13 wherein at least the first edge has second and third edge eyelets disposed on opposite sides of the center eyelet.

17. The method of claim 16 wherein engaging the tarpaulin includes first engaging the center edge eyelet with the hook, next engaging the first and second edge eyelets with the hook, and then engaging the first and second corner eyelets with the hook.

18. The method of claim 17 wherein each eyelet is defined by a grommet.
